(19) United States
(12) Patent Application Publication
(10) Pub. No.: US 2009/0072446 A1
(43) Pub. Date: Mar. 19, 2009

(54) Process of making a vehicle airbag cover

(75) Inventors: Mitsuo Yasuda, Nanto-shi (JP); Yusuke Ishikuro, Nanto-shi (JP)

Correspondence Address: W. NORMAN ROTH, 523 W. 6TH STREET, SUITE 707, LOS ANGELES, CA, 90014, US

(73) Assignee: Sanko Gosei Kabushiki Kaisha, Nanto-shi (JP)

(21) Appl. No.: 12/291,936

(22) Filed: Nov. 15, 2008

Related U.S. Application Data
(62) Division of application No. 11/392,279, filed on Mar. 29, 2006.

(30) Foreign Application Priority Data
Apr. 6, 2005 (JP) 2005-109997

(51) Int. Cl. B29C 35/08

(52) U.S. Cl. 264/400

(57) ABSTRACT

The present invention provides for an automobile-use interior cover for accommodating an airbag apparatus, the said cover 11 being processed to have an airbag expansion and release-use fracture-opening weakened line section.

The automobile-use interior cover 11 consists of a single laminated layer by laminating in such a manner of welding a hard polypropylene resin base plate layer 111 of desired thickness, a middle layer of foamed polypropylene resin 112 of desired thickness that is attached to the upper surface of the hard polypropylene base plate 11, and an outer upper layer 113 covering and attached to this foamed polypropylene resin middle layer 112. The outer upper layer 113 itself consists of two component layers 113A and 113B, both composed of thermo-plastic polyolefin (TPO), each of which is made of material differing from each other in the degree of their physical ability to absorb infrared radiation. The lower cover layer component 113B having a high rate of absorption of infrared radiation is positioned facing to the surface of the foamed polypropylene resin middle layer 112.

### BACKGROUND OF THE INVENTION

1. Field of the Invention

The present invention relates to an instrument panel cover installed in an automobile (hereinafter referred to as an “interior cover”), wherein a weakened fracture opening line is processed in the rear surface of this interior cover by irradiating a laser beam for the purpose of making dan airbag expansion and release section in the interior cover.

2. Description of the Related Art

An airbag apparatus that is installed for the front passenger seating and for the driver seating, etc. basically consists of an airbag, an airbag case to accommodate the airbag in a folded condition in such a way that the airbag can easily unfold and expand, and an inflator for inflating the folded airbag in a short time. Especially, in the case of an airbag apparatus used for the front passenger seat and installed inside the instrument panel cover (interior panel) that comprises the dashboard, if a vehicle collision or the like occurs and the vehicle rapidly loses speed, the inflator functions and the high pressure gas from the inflator rapidly inflates the airbag. Simultaneously, the airbag breaks through to the outside of the expanding section of the interior panel cover and provides a cushion effect for the passenger.

Generally, the interior cover consists of a panel core made of plastic material such as polypropylene resin and a single surface layer that covers the core made of plastic material such as polypropylene resin. Or, it consists of a laminated layer by laminating a hard polypropylene resin base panel, a middle intermediate layer of foamed plastic made from polypropylene resin, and an aesthetically decorative laminated outer skin layer made from polyvinyl resin or from thermo-plastic polyolefin resin (TPO).

In addition, a weakened fracture opening line for releasing and expanding the airbag is made in the interior cover. For this weakened line for fracture opening, for example, a carbon dioxide gas laser or other laser beam is used to create incisions in the back of the interior cover. By monitoring the depth of penetration of the laser beam into the interior cover, or by measuring the thickness of the material that remains under the weakened line, the thickness of the material under the weakened line not removed by the laser beam can be kept at an approximately constant thickness. When viewed from the outside, the tapholes are less visible and a seamless effect is obtained.

Next, FIG. 1 shows the prior art of the method for making a weakened fracture-opening line in a n outer laminated layer of an interior cover made from thermo-plastic polyolefin (TPO) as disclosed by PCT/GB09/01947.

In FIG. 1, the fracture-opening weakened line processing device 1 is composed of the laser beam generating device 2 that fires beams in pulses, and a sensor device 3 that is located with the predetermined spacing from the laser beam generating device 2 in the direction of irradiation beams 2A to be irradiated in the opposite side of the laser beam generating device 2. An interior cover 4 is placed between the laser beam-generating device 2 and sensor device 3. The interior cover 4 is constructed so as to move at a suitable speed by means of a multi-axis positioning device 10 along the path of the fracture-opening weakened line.

The interior cover 4 consists of a base plate 4a of hard polypropylene resin of the desired hardness, a middle intermediate layer 4b of foamed polypropylene resin of the desired thickness attached to the hard polypropylene base plate 4a, and an outer upper surface cover 4c formed from black thermo-plastic polyolefin (TPO) into which a black carbon pigment is mixed, covering the middle layer 4b.

For the laser beam 2A emitted from the laser beam generating device 2, an infrared beam with a wavelength of 10.6 micrometers is used.

The fracture-opening weakened line in the interior cover 4 is processed by irradiating the interior cover 4 with the laser beam 2A generated by the laser beam generating device 2 while moving the interior cover 4 by means of multi-axis positioning device 10 along the weakened line pattern, thereby producing incisions by removing materials mainly with the fusing and shearing effect by the laser beam, and partially with other effects such as material evaporation and chemical degradation.

When the laser beam 2A is irradiated to the back surface of interior cover 4 and then incomes into the upper layer 4c, it can be detected by the sensor device 3 just before the laser beams completely passes through the upper layer 4c. Based on this detection function, the amount of penetration (for example, the amount of remaining material has a material thickness of 0.3 mm) is measured, and the results of these measurements are inputted into the system controller 6 that controls the entirety of the weakened line processing device 1. Then, in the system controller 6, on the basis of the penetration measurements generated by the sensor device 3, the reference points are set so that the thickness of the remaining material 7 (approximately, 0.3 mm) at the site of the weakened line in the interior cover 4 remains constant. In other words, when the incision tapholes are made, the number of pulses of the laser beam 2A per unit time and the irradiation time by the laser beam 2A shorter than the actual irradiation time are set in order to maintain the preset thickness of the un-processed remaining material 7 (see FIG. 2) required for the weakened line incision tapholes 8 so that the system controller 6 controls laser beam 2A and a weakened line with the required consistent thickness of remaining material so as to obtain these preset values,

Therefore, as shown in FIG. 2, by moving the interior cover 4 from the original stage when the weakened line tap holes 8 are to be made first, toward the laser beam 2A in steps by the multi-axis positioning device 10 (not shown), the weakened line tap holes 8 are obtained in the interior cover 4 maintaining the untouched material with the preset thickness 7.

However, in the conventional method for processing the weakened line, since a fracture-opening line is formed in the interior cover by a laser source such as a carbon dioxide gas laser that produces a infra-red laser beam having a wavelength of 10.6 micrometers, when the laser beam 2A is irradiated against interior cover 4, the fusion shearing effect causes over-heating the irradiated part of interior cover 4.

When the Interior cover 4 consists of a hard propylene resin base plate 4a, a middle layer 4b made of foamed polypropylene resin of the desired thickness that is attached to the hard propylene resin base plate 4a, and an outer cover 4c for this middle layer 4b, the prior art facilitates the laser processing at the outer layer of the interior cover in such a manner that the outer uppermost covering layer 4c as the outer layer of the interior cover is made of a black outer layer material of thermo-plastic polyolefin resin into which a carbon black dye having high laser processing workability is added.

However, this means that the interior cover outer covering layer 4c is completely black and its outer appearance and aesthetic decorative appearance is bad, so that there is still a need for materials with a richer variety of colors.

In order to solve this problem and provide more aesthetic decorative qualities, in some cases, carbon black dye is not mixed into the thermo-plastic polyolefin resin, and, instead, other color dyes having high level permeability while having low level laser process workability characteristics are mixed into the thermo-plastic polyolefin material used for the outer covering 4c which provides red, yellow and blue/green, etc. However, when this is done, the laser beam 2A passes completely through the outer covering and reaches the sensor 3 before tapholes could have been made, thereby causing it to stop the laser beam 2A irradiation cutting process by the signals from the sensor 3, so that it is impossible to carry out laser beam cutting processing for these thermo-plastic polyolefin type outer coverings 4c. In addition, when the outer covering cutting processing is carried out for said outer coverings 4c ignoring these factors, such processing results in destruction of the sensor device 3.

In addition, there are still other problems related to the interior cover 4 fracture-opening weakened line wherein thermal expansion and/or deformation occur in the part corresponding to a fracture-opening line of the outer covering 4c that cause deterioration of the aesthetic appearance of outer surface of the interior cover 4. Especially, in cases where a middle layer of foamed polypropylene is disposed between the hard resin base plate and an aesthetically decorative outer covering layer, the releasing of heat outside the interior cover decreases because of the insulating characteristics of the middle layer foamed polypropylene, thereby further increasing the temperature of the laser beam-irradiated section, resulting in the aesthetically decorative uppermost layer surface changed color and deformation being increased and the aesthetic appearance of the outside surface of the interior cover as seen from the outside getting worse and worse.

### SUMMARY OF THE INVENTION

In view of the foregoing, a main object of the present invention is to provide the method for easily applying the laser beam cutting processing into part of the uppermost covering layer by a laser beam even if such resin colors as red, yellow and blue/green thermoplastic polyolefin resin having low laser processing performance are used to make the laminated uppermost surface covering of the internal cover,

Moreover, the second object of the present invention is to provide a laminated interior cover for an airbag apparatus wherein it can prevent the aesthetic appearance of the interior cover outer surface from getting worse by eliminating the problems of the change in color and deformation of the interior cover surface caused by the heat of the laser, and can simplify the process for making the weakening line for the airbag expansion and release section to the laminated interior cover.

The above-described objects of the present invention are accomplished by the automobile interior cover related to airbag apparatus (the interior cover referred to above), wherein the interior cover constructed into a single complete laminated layer by laminating the hard polypropylene resin base plate with a desired thickness or the middle intermediate layer of foamed polypropylene with a desired thickness attached to said hard polypropylene resin base plate, and the upper covering layer formed of thermo-plastic polyolefin (TPO), respectively, in such a manner of welding; wherein said upper covering layer is composed of two component layers that have differing laser processing workability characteristics, respectively, such as high laser processing workability and low laser processing workability, one component layer with the high laser processing workability being disposed facing to the basic hard polypropylene resin base plate or the middle intermediate layer of foamed polypropylene, thus making it possible to give good laser cutting processing performance to the inner component layer having the high laser processing workability even when the uppermost component layer of the laminated layer is made of thermo-plastic polyolefin containing red, yellow or blue/green and other colors which have high level permeability, but have low level laser process workability characteristics, thereby surely controlling the level of the material remaining after the cutting operation, thus resulting in a seamless fracture opening weakened line being made without problems

Moreover, when the uppermost layer is made of said thermo-plastic polyolefin (TPO) having high laser processing workability characteristics into which brown dye is added, it becomes possible to easily distinguish the laser processing level by means of adding to the brown thermo-plastic polyolefin layer a few percent of black carbon dye that can be visible as the mixed black color appeared in the brown layer surface.

In addition, the present invention provides the interior cover for the airbag apparatus as constructed into a single laminated layer; wherein the problem of deterioration of the aesthetic appearance of the cover surface layer can be solved by eliminating the deformation and change in color of the surface layer of the interior cover and the weakened line can be easily processed in the interior cover for the airbag expansion and release section of the cover.

### BRIEF DESCRIPTION OF THE DRAWINGS

Various other objects, features and many of the attendant advantages of the present invention will be readily appreciated as the same become better understood by reference to the following detailed description of the preferred embodiments when considered in connection with the accompanying drawings, in which:

FIG. 1 is a block diagram showing the overall configuration of the conventional weakened line-processing device;

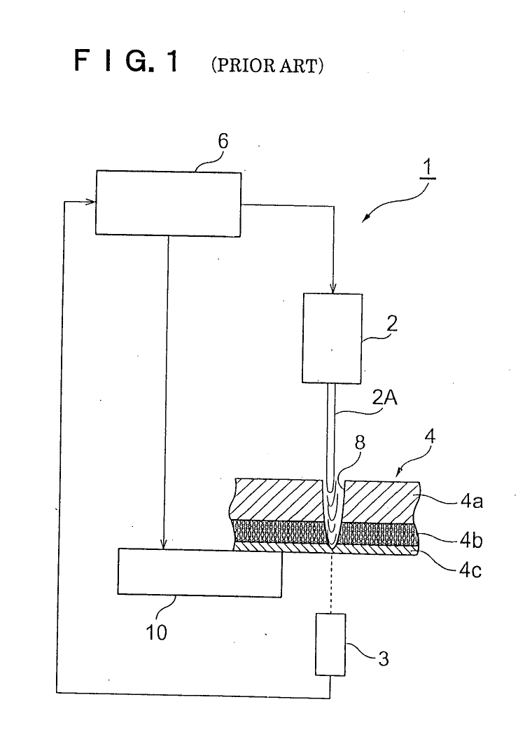

FIG. 2 is an enlarged cross-sectional view of one embodiment of the fracture opening weakened line made in an interior cover by the conventional weakened line-processing device:

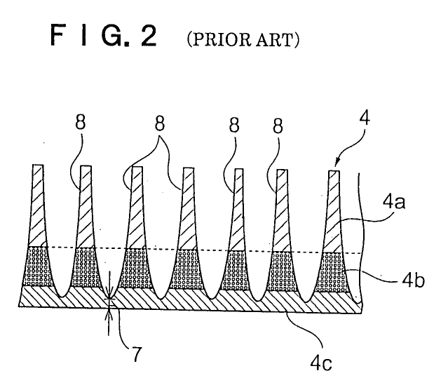

FIG. 3 is a plan view of the main parts of the automobile interior panel cover for accommodating an airbag apparatus according to one embodiment of the present Invention.

FIG. 4 is a block diagram showing the overall configuration of the weakened line-processing device for making a weakened line in the automobile-use interior cover for accommodating the airbag apparatus according to the present Invention:

FIG. 5 is an enlarged cross-sectional view taking the line of 4-4 in FIG. 4, showing the state with the fracture-opening weakened line processed in the automobile-use interior cover for accommodating an airbag apparatus according to the present Invention.

FIG. 6 is a view similar to FIG. 5 of the first embodiment, showing the second embodiment of an automobile-use interior cover for accommodating an airbag apparatus according to the present invention.

### DESCRIPTION OF THE PREFERRED EMBODIMENTS

The automobile interior cover for an airbag apparatus will next be described with the reference to the drawings.

### First Embodiment

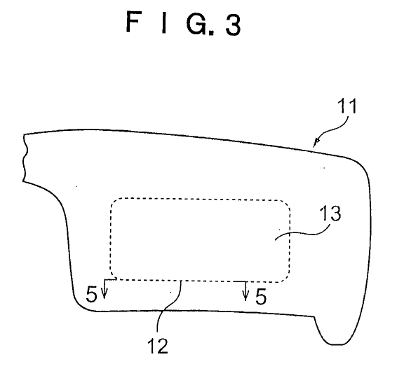

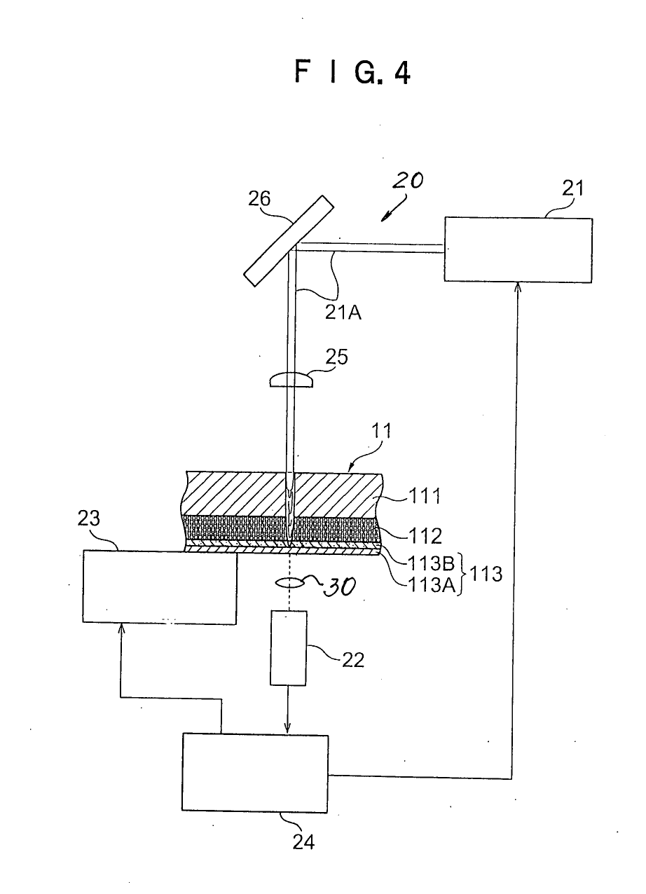

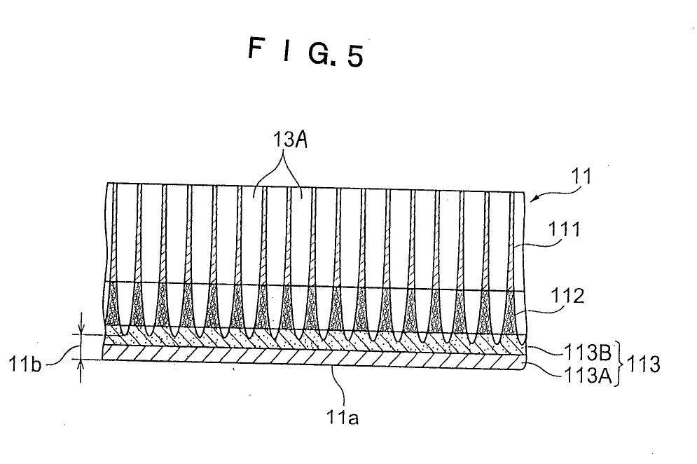

FIG. 3 is a plan view of the main parts of the automobile-use interior cover for accommodating an airbag apparatus according to the present invention, FIG. 5 is an enlarged cross-sectional view taking along the line of 5-5 of FIG. 4 showing the state with the fracture-opening weakened line being processed in the automobile interior cover for accommodating an airbag apparatus according to the present Invention.

The rear surface of the interior cover 11 is not shown but designed to accommodate the airbag apparatus. The area indicated by the dashed line is the fracture-opening weakened line 12 and the area enclosed by the dashed line is the airbag expansion and release section 13.

FIG. 4 is a block diagram showing the overall configuration of the weakened line-processing device for use in making a weakened line in the automobile interior cover for the airbag apparatus according to the present invention.

When the internal cover 11 is processed, for the fracture-opening weakened line 12 that becomes the airbag expansion and release section 13, the aforementioned conventional processing method is used. That is, the weakened line-processing device system 20 consists of a laser beam source 21, a sensor device 22, a multi-axial positioning device 23, and a control system 24; wherein the laser beam source 21 generates a laser beam in pulses; the sensor 22 is located with the predetermined spacing from the laser beam source 21 in the direction of irradiation beams 21A to be irradiated and measures the penetration amount of a laser beam 21A which penetrates the fracture-opening weakened line 12 or the interior cover 11 when the fracture-opening weakened line 12 is made in the interior cover 11; the multi-axis positioning device 23 moves the interior cover 11 positioned between the laser beam source 21 and the sensor device 22 at a suitable speed and along the weakened line pattern of the fracture-opening weakened line 12 to be processed in the interior cover 11; and the control system 24 controls the multi-axial positioning device 23 as well as the number of pulses and the time of irradiation of the laser beam 21A per unit time so as to maintain the preset thickness 11b (see FIG. 5) of the un-processed remaining material constant at the site of the surface 11a opposite to the rear surface of the interior cover 11 based on the amount of penetration measured by the sensor device 22.

Said interior cover 11 consists of the following components: a hard propylene resin base plate 111 having 2.5 mm-3.5 mm in thickness, a middle layer of foamed polypropylene resin 112 having 1.3 mm-3.0 mm in thickness attached to the base plate 111, and a 2-component outer front cover layer 113 made of thermo-plastic polyolefin resin (TPO) consisting of an upper surface layer 113A and an under-layer 113B having 0.3-0.8 mm in thickness.

The two-component outer front cover layer 113 is made by laminating two-component layers consisting of the under-layer 113B 0.15-0.4 mm in thickness formed of the thermo-plastic polyolefin resin (TPO) into which a few percent of carbon black dye are added to have a high laser processing workability, and the top layer 113A having a thickness of 0.15-0.4 mm made of thermo-plastic polyolefin resin (TPO) into which, as coloring agents, are added red, yellow and blue/green dyes such as red (Fe₂O₃), yellow (FeO(OH).nH₂O), Titanium oxide, akadomi red, quinacridone red, Cobalt blue, ultramarine blue and other colors, in place of black dye.

The laser beam 21A produced by the laser beam source device 21 is 0.2-0.5 mm in diameter and has a wavelength of 10.6 micrometers and is infrared by type.

Next, the processing operations for making the fracture-opening weakened line based on this embodiment of the Invention are explained.

First, the interior cover 11 is set in the multi-axis positioning device 23 with the rear surface of the interior cover 11, that is, the hard polypropylene resin base plate 111 being directed to the site where the laser beam 21A is irradiated. Then, the interior cover 11 is moved at a set speed along the fracture-opening weakened line 12 pattern, by controlling the multi-axial positioning device 23 based on control signals from the system controller 24, as shown in FIG. 4.

At the same time, the laser beam source 21 is turned on to generate the laser beam 21A according the control signals from the system controller 24. The laser beam 21A is emitted by the laser beam source device 21 and irradiates the rear surface of the interior cover 11.

Thus, the tapholes 13A used for the weakened line are created in the interior cover 11 by removing the material by a shearing effect based on the sublimation, oxidation and combustion effects.

When the tapholes 13A used for the weakened line have been created in the interior cover 11, the laser beam enters the sensor device 22 and the amount of penetration by the laser beam is measured by the sensor device 22 and the results of these measurements are sent to the system controller 24. According to the amount of penetration measured by sensor device 22, the system controller 24 sets the reference points necessary to maintain a constant thickness of the material of 11b remaining uncut inside the interior cover 11, and the laser beam 21A is controlled by the laser beam 21A according to the reference points, so that the weakened line tapholes 13A are formed with the thickness of the remaining uncut material 11b, as shown in FIG. 5. Consequently, the multiple tapholes 13A are made along the fracture-opening weakened line 12.

### Second Embodiment

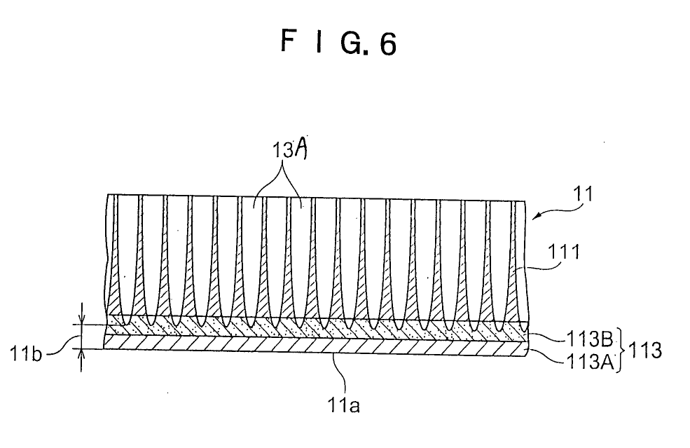

FIG. 6 is a view similar to FIG. 5 showing the First Embodiment and shows the finished automobile interior cover fracture-opening weakened line tapholes for the second embodiment.

In this second embodiment, said interior cover 11 consists of the following components: a hard propylene resin base plate 111 having 2.5 mm-3.5 mm in thickness, and a two-component outer front cover layer 113 made of thermo-plastic polyolefin resin (TPO) having 0.3-0.8 mm in thickness. The two-component upper layer 113 is made by laminating in various ways such as adhesives and welding the two-component layers that consist of the under-layer 113B 0.15-0.4 mm in thickness formed of the thermoplastic polyolefin resin (TPO) into which a few percent of carbon black dye are added to have a high laser processing workability, and the uppermost top layer 113A having a low laser processing workability and a thickness of 0.15-0.4 mm made of thermo-plastic polyolefin resin (TPO) into which pigments such as an iron oxide dye etc. are added to appear red, yellow and blue/green color for improving the aesthetic appearance of the uppermost front layer.

Therefore, compared to the interior cover 11 in the first embodiment, the interior cover 11 of the second embodiment does not have an intermediate middle layer of foamed polypropylene resin which is disposed between the hard polypropylene resin base plate 111 and the outer front cover layer 113 in the first embodiment, while other constituent elements are substantially the same.

Moreover, the fracture-opening weakened line 12 in the interior cover 11 according to the present invention can be not only limited to the design as shown in FIG. 5 where the weakened line-use multiple tapholes 13A are processed at regular intervals, but can be also designed such that the tapholes 13A are processed by overlapping each other in succession.

1. A process of making a vehicle airbag cover comprising the steps of:
a) providing a polypropylene resin base plate having a desired thickness;
b) providing a multi-layer sheet of thermo-plastic polyolefin resin (TPO) having an inner TPO layer of high laser processing workability containing black carbon dye facing said base plate and an outer TPO surface layer of low laser processing workability containing at least one color other than black;
c) placing said base plate on said multi-layer sheet with said inner TPO layer facing said base plate and said base plate facing a laser;
d) producing a fracture line in said cover by irradiating said base plate with a beam from said laser to produce said fracture line as a series of holes of desired depth extending through said base plate and into said inner TPO layer of said multi-layer sheet;
e) sensing the amount of penetration of said laser beam into said inner TPO layer; and
f) controlling said laser in accordance with the sensed amount of penetration of said laser beam to leave said outer TPO surface layer essentially un-processed and essentially constant in thickness.

2. The process of claim 1, wherein said holes are produced by a laser beam 0.2-0.5 mm in diameter.

3. The process of claim 2, wherein said laser beam is a pulsed (p 10, 1 1) infrared beam having a wavelength of 10.6 micrometers (P 11, 1 17-19).

4. The process of claim 1, including the step of placing said inner TPO layer in contact with said base plate.

5. The process of claim 1, including the step of providing an intermediate layer of foamed polypropylene between said base plate and said multi-layer sheet.

6. An airbag cover produced by the process of claim 1.

7. An airbag cover produced by the process of claim 3.

8. An airbag cover produced by the process of claim 4.

9. An airbag cover produced by the process of claim 5.

10. An airbag cover produced by the process of claim 6.
